(19) United States
(12) Patent Application Publication
(10) Pub. No.: US 2023/0033579 A1
(43) Pub. Date: Feb. 2, 2023

(54) Protective Device

(71) Applicants: Daniel John Hyman, LONG BEACH, CA (US); Kajornpat Zithisakthanakul, Ontario, CA (US); T.-Y. Tang, Palos Verdes Estates, CA (US)

(72) Inventors: Daniel John Hyman, LONG BEACH, CA (US); Kajornpat Zithisakthanakul, Ontario, CA (US); T.-Y. Tang, Palos Verdes Estates, CA (US)

(21) Appl. No.: 17/386,509

(22) Filed: Jul. 27, 2021

(51) Int. Cl. A62B 18/04; A62B 18/00; A42B 3/28; A42B 3/20; A42B 3/22

(52) U.S. Cl. CPC A62B 18/045; A62B 18/003; A42B 3/286; A42B 3/20; A42B 3/225

(57) ABSTRACT

An air purifying device including means for reducing air resistance between the air filtering elements and the target locations for the purified air. Reduced air resistance lowers the energy consumed by the device, thereby reducing its size and weight as well as improving ease of integration with a variety of head gear.

### CROSS REFERENCE TO RELATED APPLICATIONS

This patent application is claiming priority under 35 USC 119(e) to provisional patent application entitled “Protective Equipment” having a provisional application Ser. No. 63/103376, a mailing date of Jul. 31 2020 and filing date of Aug. 4 2020.

### REFERENCES CITED

### U.S. Patent Documents

1. Publication Number: U.S. Pat. No. 7,937,775 B2

Assignee: Microtek Medical Inc.

Title: SURGICAL PROTECTIVE HEAD GEAR ASSEMBLY INCLUDING HIGH VOLUME AIR DELIVERY SYSTEM

Date of Patent: May 10, 2011

Filing Date: Aug. 8, 2006

2. Publication Number: US 2009/0314295 A1

Assignee: E.D. BULLARD COMPANY.

Title: POWERED AIR PURIFYING RESPIRATOR

Publication Date: Dec. 24, 2009

Filing Date: Dec. 19, 2007

### Other Publications

1. U.S. CDC/N.I.O.S.H. government document: Determination of Filter Particulate Efficiency Level for N95 Series Filters Against Solid Particulates for Non-Powered Air Purifying Respirators Standard Testing Procedure. December 13, 2019. Procedure number: TEB-APR-STP-0059.

2. U.S. EPA government document: What is a HEPA filter? www.epa.gov/indoor-air-quality-iaq/what-hepa-filter-1 (As of Jul. 23, 2021)

3. U.S. NIH government document: The Use and Effectiveness of Powered Air Purifying Respirators in Health Care: Workshop Summary. 2. Defining PAPRs and Current Standards. ISBN-13: 978-0-309-31595-1. ISBN-10: 0-309-31595-6.

### BACKGROUND OF THE INVENTION

The present invention relates to air purifying devices with improved energy efficiency and ease of integration with a variety of head gear.

Air purifying devices such as powered air purifying respirators (PAPRs) are designed to protect the health of a user by limiting exposure to various environmental dangers and contaminants including but not limited to SARS-CoV-2 and other viruses, bacteria, pollution, Hay Fever-causing pollen and other allergens, dust, mold, radioactive airborne contaminants, and wildfire smoke.

PAPRs and other air purifying devices protect users from these and other airborne hazards and are produced by many suppliers including but not limited to 3M, Honeywell, Bullard, and Maxair.

A common design for PAPRs separates the system into an air filtering unit, a head piece that is worn by the user, and a tube that connects the air filtering unit to the head piece. It is apparent to those skilled in the art that the tube typically adds air resistance, thereby requiring more energy to push purified air from the air filtering unit to the head piece. It is also apparent to those skilled in the art that PAPRs that require more energy typically means the need for larger, heavier and more expensive batteries or electrical power supply, longer or higher-power electrical charging, or some combination of energy management circuitry and components to support the energy needs. Furthermore, there is public resistance to wearing masks for COVID-19 protection due to the appearance of masks. In comparison, a PAPR is much larger than a mask, and a tube-connected multi-part system makes the user appear even more unusual and can be less socially tolerated in everyday life.

Maxair introduced a tubeless PAPR that incorporates the air purifying means into the head gear to eliminate the need for a tube. It is apparent to those skilled in the art that this improvement enables smaller and lighter PAPRs that are less cumbersome for the user. This tubeless PAPR design is disclosed in U.S. Pat. No. 7,937,775 B2 and uses an air channel formed using different sections of the device to guide purified air from the air purification components to the front end of the PAPR device near the face of the user. Another advantage of the smaller tubeless PAPR system is that it may make the user appear less unusual compared to the tubed PAPR system.

It is apparent to those skilled in the art that the Maxair PAPR's air channels may reduce air resistance compared to tubed PAPR systems. However, Maxair's air channels still may have air resistance with associated size, weight, power consumption, and complexity of the PAPR headgear. The Maxair PAPR device is generally significantly larger and bulkier than typical headwear such as hats and visors. Thus, it would be apparent to those skilled in the art that it would be difficult to integrate a PAPR device like the Maxair PAPR with everyday headwear such as hats and visors. Such an integrated device will likely appear unusual for everyday life and may be less socially accepted.

### SUMMARY OF THE INVENTION

An air purifying device reduces the air resistance between the air purifying components and the target locations for the purified air by reducing the need for tubes and/or air channels. Reduced air resistance lowers the energy needed for the device, thereby reducing the size and improving the ease of integration into a variety of head gear. Head gear includes but is not limited to hat, cap, visor, face shield, helmet, football helmet, baseball cap, hood, respirator, and powered air purifying respirator.

The air resistance of the air purifying device is reduced by attaching a portion of or substantially all the components of the air purifying unit to a brim, wherein said brim can be at least a portion of a head gear, separate from the head gear, or any combination thereof. At least a portion of said brim may be at least a portion of the housing for the air purifying unit. The ability to eliminate the need to form air channels from different portions of an air purifying device can reduce device complexity, cost, and manufacturing complexity. The ability to utilize a variety of commercially available head gear can also reduce manufacturing cost of the air purifying device and improve social acceptance.

An air purifying device made in accordance with the present invention generally includes a brim or equivalent, at least one air filtering unit, at least one air conducting means, and optional optical window. Said brim may be separate from the head gear, a portion of a head gear, or any mechanically fastened or attachment combination thereof. Said air filtering unit includes at least one fan, at least one filter, and at least one source of electrical power with means of control. Air conducting means include but is not limited to having (1) filtered air from the air filtering unit is pointed approximately directly at or substantially aligned with the target areas of the user without any additional air conduction means after filtering, (2) nozzles, (3) fan housing nozzles, (4) flat or curved surfaces that direct or guide air flow after air is passed through from at least one fan.

An air purifying device with reduced air resistance made in accordance with the present invention may require less electrical power for an equivalent air flow and filtration level as compared to air purifying devices constructed using conventional architectures. Reduced power requirement results in a variety of benefits including but not limited to smaller size, lower weight, reduced moment of inertia which is a technical characteristic critical for headgear, less bulky device and lower cost. Reducing the size, weight, and moment of inertia of the device and air filtration components typically simplifies and/or enhances the integration of air purifying functions to head gear for different applications including but not limited to medical, industrial, nuclear, customer service, everyday wear, and sports equipment. Enhancing the integration of smaller air purifying components can help camouflage the air purifying means when integrating with everyday head gear such as hats, visors, caps, and face shields, as well as sports equipment such as football helmets, baseball helmets, and baseball caps. For medical, nuclear and other industrial uses, reducing the size and weight of the air purifying device also is desirable for users who may need to wear protective equipment for many hours with reduced head, neck, and/or vision strain.

### DESCRIPTION OF THE DRAWINGS

FIG. 1A is a front view of an embodiment of an air purifying device without a head gear and with an air filtering unit and optical window, which serves also as a face shield. FIG. 1B is an exploded view of an air filtering unit embodiment of FIG. 1A.

FIG. 2A is a side view of an air purifying device embodiment with a head gear. FIG. 2B is an exploded side view showing several components of an air filtering unit embodiment including cover, housing, and fan of FIG. 2A.

FIG. 3A is an isometric view of an air purifying device embodiment with a cover and an optical window that can be rotated. Head gear is not included in the figure. FIG. 3B is an exploded view of an air filtering unit embodiment with attachments for an optical window that can be rotated from FIG. 3A.

FIG. 4 is a side view of an air purifying device embodiment with a head gear as worn by a user.

### DETAILED DESCRIPTION OF THE INVENTION

The present invention is an air purifying device that reduces air resistance between the air purifying components and the target locations on the user by eliminating the need for tubes and air channels, and therefore reducing the power and capability requirements for air conducting means. Reduced air resistance lowers the energy needed for the device, thereby reducing size and improving the ease of integration into a variety of head gear. Air resistance is reduced by attaching a portion or substantially all of the components of the air filtering unit to a brim of a head gear selected from: hat, visor, cap, face shields, helmet, football helmet, baseball cap, hood, respirator, powered air purifying respirator, baseball helmet and head gear for athletics.

Police and social media records identified an increase in intimidation, violence, and anger directed against those wearing facemasks and other personal protective equipment during the COVID-19 crisis. Consumer spending is often based on consumer psychology and sentiment. To address these issues, integration of air filter systems into sports equipment, ordinary clothing, and accessories, such as but not limited to hats, visors, caps, and face shields, can allow persons to wear safety equipment while better blending into everyday life with increased public acceptance. This may help protective equipment become a part of a ‘new normal’ if COVID-19, variants, and/or other airborne dangers continue to persist as a threat in the U.S. and abroad. An air purifying device with reduced air resistance made in accordance with the present invention may require less electrical power. Reduced power can provide benefits including but not limited to smaller size, lower weight, less bulky device, reduced moment of inertia, and typical associated lower procurement and operating cost. Reducing the size, weight, and moment of inertia of the device simplifies and/or enhances the integration of air purifying functions to head gear appropriate for different applications including but not limited to medical, industrial, nuclear, customer service, everyday, and sportswear. Smaller air purifying components help camouflage the air purifying means when integrating with everyday head gear such as hats, caps visors and face shields, as well as sports equipment such as football helmets and baseball caps. For medical, nuclear, and other industrial uses, reducing the size and weight of the air purifying device also are desirable for users who may need to wear protective equipment for many hours with reduced head, neck, and/or vision strain.

An air purifying device made in accordance with the present invention generally includes a brim, at least one air filtering unit, at least one air conducting means, and optional optical window. Said brim may be separate from the head gear or may be a portion of a head gear or a separate structure that is affixed to the brim or other protective element of head gear. Said separate structure may optionally be the housing for at least a portion of said air filtering unit.

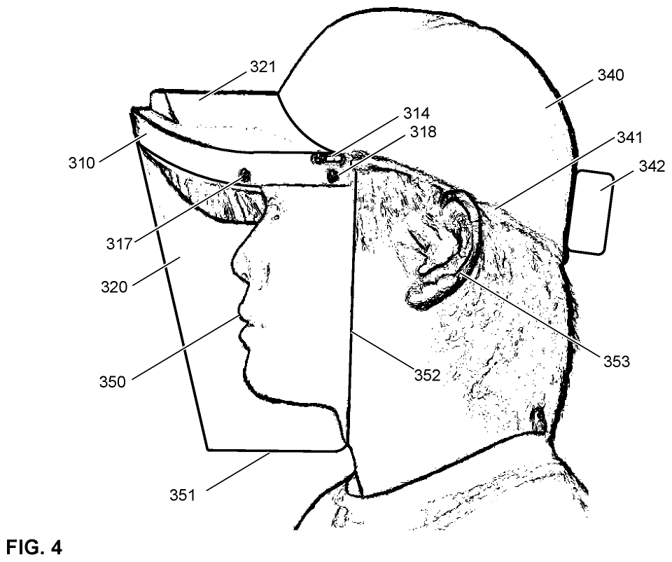

Said air filtering unit includes at least one fan, at least one filter, and at least one source of electrical power. Said source of electrical supply can be divided into different locations beyond the brim, such as but not limited in the same housing near the brim, attached to the rear of the head gear or separate from the system but attached by wiring. FIG. 4 shows an embodiment wherein at least a portion of the source of electrical power is attached to the rear of the head gear. An embodiment that separates the source of electrical power will typically reduce the weight of the system worn on the head. Said source of electrical power can be separate into more than 1 section. In one embodiment, the control/drive electronics are attached near the head gear while the heavier batteries are separated and connected by wiring. Reducing the weight attached to the brim area has additional benefits, such as but not limited to better weight balance between the front and back of the hear gear, which can be important particularly if the device is worn for a longer time period. In activities such as sports, better weight balance also can improve user experience and performance when the user's head has to swing rapidly back and forth.

Said electrical fan or blower can be produced by suppliers such as Pelonis or Cooltron. The fans or blowers are known to those skilled in the art include but are not limited to axial fans and centrifugal fans. For sports equipment or applications requiring miniaturization, the use of small fans can optionally enable smaller air intakes that may make helmets more impact resistant and retain more cushioning materials and structures that minimize mechanical impact to the wearer. The use of multiple smaller fans can provide similar air flow as larger fans while improving mechanical strength of the head gear.

Filter and filter materials to be used can be selected from a list of filters and filter materials apparent to those skilled in the art and include but are not limited to HEPA filter materials, filter materials used in various N95/KN95/N100 filters, electrostatically charged materials or trap layers, nanospun material-based filter materials, polypropylene fiber based filter materials, nanoperforated filter materials, or any combination thereof. It is apparent to those skilled in the art that HEPA filters remove at least 99.97% of 0.3 micron mean mass diameter particles and KN95/N95 filters remove at least 95% of 0.3 micron mean mass diameter particles.

Air conducting means include but is not limited to nozzles, fan housing nozzles, pointing filtered air approximately directly at or substantially aligned with the target areas of the user after filtering without any additional air conduction means, flat or curved surfaces that direct or guide air flow after air is ejected from at least one fan. The elimination of tubes and long air channels from the prior art will reduce the power consumption and the size of the air purifying device.

Electrical power sources to be used are apparent to those skilled in the art including but not limited to batteries, fuel cells, capacitors, supercapacitors, photovoltaic cells, other power sources, or any combination. Electrical power sources are typically controlled and powered by power circuitry and control circuitry to control the voltage and current for powering fans. Electrically connecting the electrical power source to electrical fan by various means including wiring and other means is apparent to those skilled in the art.

In one embodiment, an air purifying device comprises of: a brim, at least one air filtering unit, at least one air conducting means, optional optical window and at least one head gear, wherein said air filtering unit comprise at least one filter, at least one fan, and at least one electrical power supply, wherein said fan is located close to said brim; wherein said brim is selected from the list of: a brim that is a part of said head gear, a brim that is not a part of said head gear, and a brim that is the housing for at least a portion of said air filtering unit, wherein said head gear is selected from the list of hat, cap, visor, face shield, helmet, hood, respirator, PAPR, powered air purifying respirator, football helmet, baseball cap, baseball helmet and head gear for athletics.

In another embodiment, an air purifying device comprise of: a brim, at least one air filtering unit, at least one air conducting means, and optional optical window, wherein said air filtering unit comprise at least one filter, at least one fan, at least one electrical power supply, wherein said fan is located close to said brim, wherein said brim is selected from a list of: a brim is that a part of the housing for at least a part of said air filtering unit, or a brim that is a part of a separate head gear and is not a part of the air purifying device.

The air purifying device may filter approximately 95% of 0.3 micron mean mass diameter particles as specified by U.S. N.I.O.S.H. specifications for N95 respirators or approximately 99.97% of 0.3 micron mean mass diameter particles as specified for HEPA filters.

At least one fan can be directly attached to the brim or to a housing that is attached to the brim, or any combination.

The order of airflow can be changed as is apparent to those skilled in the art, wherein (1) air can pass through at least one filter before passing through said fan or (2) air can pass through at least one filter after passing through said fan. The fan can be attached very close to the brim, including but not limited to being located within the brim's structural region in a way apparent to those skilled in the art that maximizes air flow, minimizes energy use, or any combination.

For sports and other applications where mechanical shock is possible, to minimize mechanical shock, said air filtering unit can be attached to the head gear using shock minimizing means apparent to those skilled in the art. This may include but is not limited to the use of flexible elements for attachment, foam, or other cushioning elements, as well as increasing the distance between the user and the air filtering unit.

In embodiments wherein using a brim is not preferred, said brim can be eliminated and at least a portion of an air filtering unit can be instead attached to a different portion of the air purifying device in a way such that filtered air from the air filtering unit can be approximately directly pointed at or substantially aligned with the desired locations on the user's face. For example, at least a portion of an air filtering unit can be attached to the face guard grid of a football helmet typically used to protect the face and mouth area of the user. If air can be directed at the face of the user, then the device can address a typical complaint that football players and other athletes often associate increased breathing effort with protective equipment close to their nose and mouth.

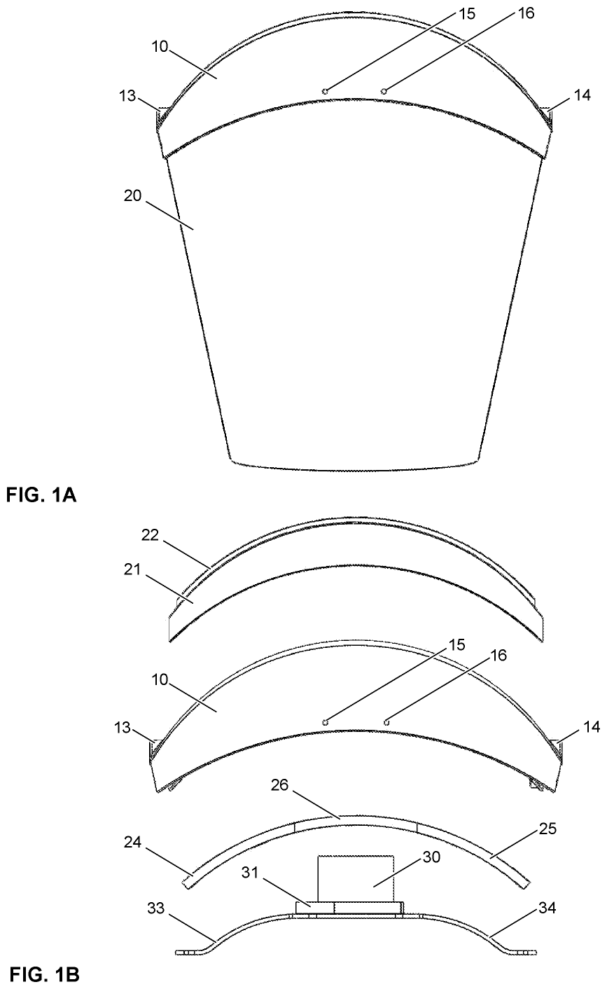

FIG. 1A is a front view of an embodiment of an air purifying device without a head gear, with an air filtering unit and with an optical window, which serves as a face shield. FIG. 1B is an exploded view of an air filtering unit embodiment. 10 is housing for air filtering unit for this embodiment. 13 and 14 are attachment points for this embodiment. 15 and 16 are optical window fasteners. 20 is optical window. 21 is cover. 22 is filter material. 24 and 25 comprise the brim wherein 26 is an opening formed in brim. 30 is fan. 31 is fan fixture. 33 and 34 are mounting plate for fan.

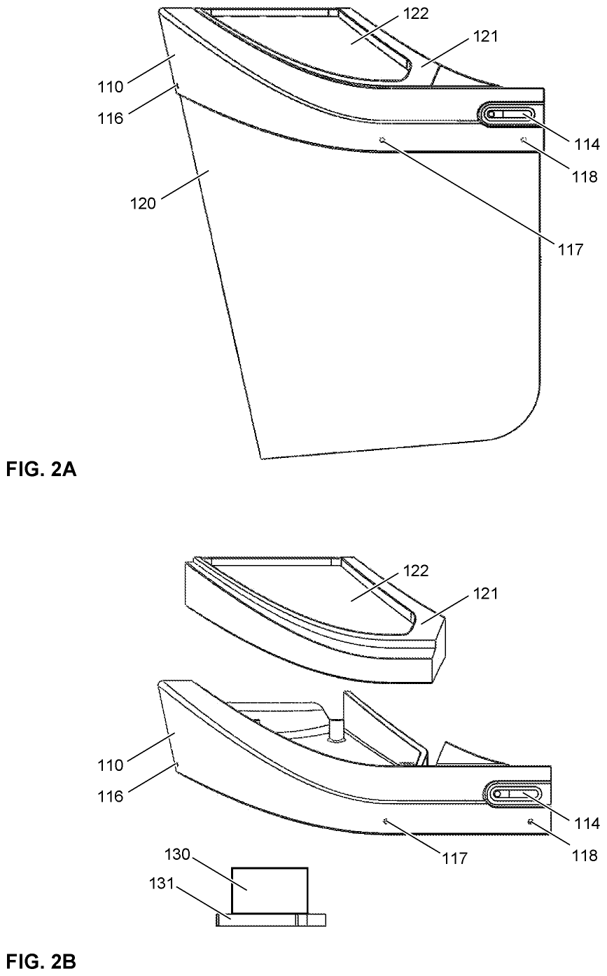

FIG. 2A is a side view of an air purifying device embodiment with a head gear. FIG. 2B is a side view of several components of an air filtering unit embodiment including cover, housing and fan. 110 is housing for air filtering unit for this embodiment. 114 is an attachment point for this embodiment. 116, 117 and 118 are optical window fasteners. 120 is optical window. 121 is cover. 122 is filter material. 130 is fan. 131 is fan fixture.

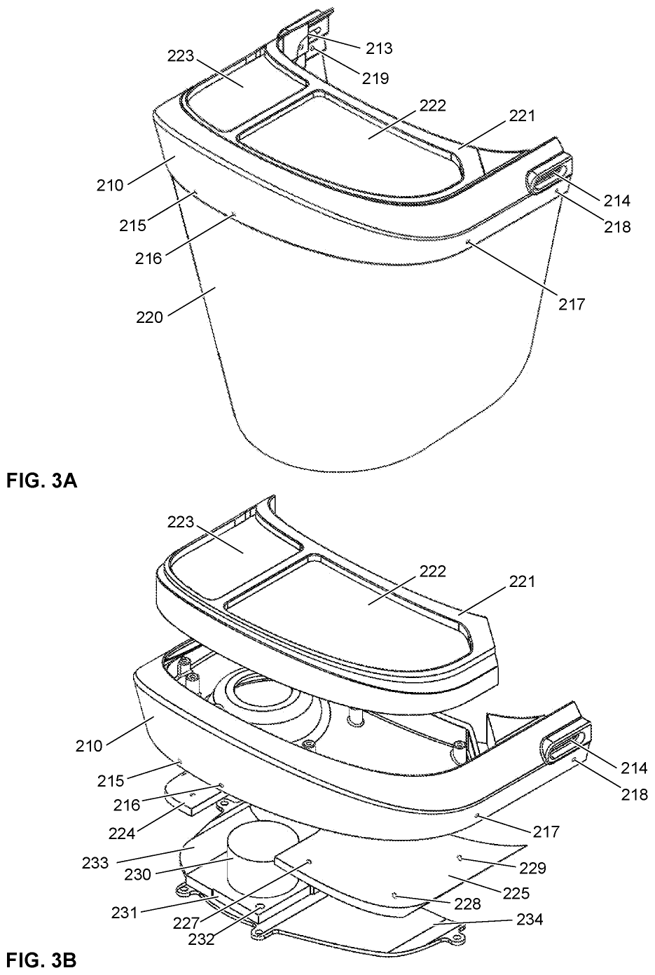

FIG. 3A is an isometric view of an air purifying device embodiment with a cover and an optical window that can be rotated. Head gear is not included in the figure. FIG. 3B is an exploded view of an air filtering unit embodiment with attachments for an optical window that can be rotated. 210 is housing. 213 and 214 are attachment points. 215, 216, 217, 218 and 219 are optical window fasteners. 220 is optical window. 221 is cover. 222 and 223 are filter material. 224 and 225 comprise brim. 227, 228 and 229 are brim fasteners. 230 is fan. 231 is fan fixture. 232 is fan fixture fastener. 233 and 234 comprise fan plate.

FIG. 4 is a side view of an air purifying device embodiment with a head gear. 310 is housing. 314 is attachment point. 317 and 318 are optical window fasteners. 320 is optical window. 321 is cover. 340 is head gear (hat). 341 is wiring. 342 is a portion of the source of electrical power. 350 is user face. 351 is gap on the bottom between optical window and the user's face where air can exit this embodiment, which is preferably minimized. 352 is gap on the side between optical window and the user's face where air can exit this embodiment, which is preferably minimized. 353 is user ear that is not covered by the device in this embodiment.

Another embodiment is a filter comprising attachment means and filter material,

wherein said attachment means provides a tight seal between said filter and an air filtering unit,

wherein said attachment means optionally holds said filter material in an approximate shape,

wherein said filter materials is selected from the list of HEPA filter materials, filter materials used in various N95/KN95/N100 filters, electrostatic filters, electrostatic traps, nanospun structure-based filters, polypropylene fiber-based filters, other filters, or any combination,

wherein said air purifying device comprising: a brim, at least one air filtering unit, at least one air conducting means, and optional optical window,

wherein said air filtering unit comprise at least one of said filter, at least one fan, and at least one electrical power supply,

wherein said fan is located close to or substantially within the physical structure of said brim,

wherein said air conducting means is selected from the list of: nozzles, fan housing nozzles, and pointing filtered air approximately directly at or substantially with the target areas of the user without any additional conduction means,

wherein said brim is selected from a list of: a brim that is a part of the housing for said air filtering unit and a brim that is a part of a separate head gear that is not a part of the air purifying device.

The inventions disclosed can include additional features that makes it even more difficult for unfiltered air from the environment to flow near or into the gaps between the body such as face, head and neck, and the air purifying device. These features are well known to those skilled in the art, and include but are not limited to: (a) adding materials at the side or bottom of the device that reduces the size of the gaps between the body and the air purifying device, (b) increasing the path length that air must flow from the environment to reach the face of the wearer, (c) other means for reducing the air flow from the environment near or in the gaps between air purifying device and the user's face such as air curtains directed near the gaps, or (d) any combination. Optionally, the air purifying device can be used with or attached to clothing items such as cowls, hoodies, and hoods.

Outside air may optionally be filtered by at least one prefilter. The prefilter may be more easily changed during maintenance. Filters also include devices that will deactivate, kill, zap or render harmless virus and/or bacteria including but not limited to any combination of devices that (1) have small physical gaps between components that have substantially different voltage potential, (2) have high temperatures, or (3) emit ultraviolet light, infrared light, UVC, electromagnetic radiation, radiation (alpha, beta, gamma), other emission, or any combination. High temperatures can be generated by heating elements including but not limited to resistive heaters, heaters based on the Peltier effect, heating elements that facilitates heating of the air by increasing the surface area of heating surfaces including but not limited to fine/microsize channels, fine/microsize pores, metal open-cell foam, and metal sponge, or any combination. Optionally, heating elements may heat air close to, at, or exceeding 100 degrees C. or temperatures that partially or completely denatures proteins.

One of ordinary skill in the art will recognize that additional embodiments are also possible without departing from the teachings of the present invention or the scope of the claims which follow. This detailed description, and particularly the specific details of the exemplary embodiment disclosed therein, is given primarily for clarity of understanding, and no unnecessary limitations are to be understood there from, for modifications will become obvious to those skilled in the art upon reading this disclosure and may be made without departing from the spirit or scope of the claimed invention.

What is claimed is:

1. An air purifying device comprising: a brim, at least one air filtering unit, optional optical window, at least one air conducting means, and at least one head gear,
wherein said air filtering unit comprise at least one filter, at least one fan, and at least one electrical power supply,
wherein at least one fan is located close to said brim;
wherein said brim is selected from the list of: a brim that is a part of said head gear, a brim that is not a part of said head gear, and a brim that is the housing of at least a portion of said air filtering unit, or any combination,
wherein said head gear is selected from the list of hat, cap, visor, face shield, helmet, hood, respirator, PAPR, powered air purifying respirator, football helmet, baseball cap, baseball helmet, and head gear for athletics,
wherein at least one air conducting means is selected from the list of: nozzles, fan housing nozzles, and pointing filtered air approximately directly at or substantially aligned with the target areas of the user without any additional conduction means.

2. The air purifying device of claim 1, wherein said brim is a part of said head gear.

3. The air purifying device of claim 1, wherein said brim is at least a part of the housing of at least a portion of said air filtering unit.

4. The air purifying device of claim 1, wherein at least one portion of said brim is a part of said head gear and at least one portion of said brim is not a portion of said head gear.

5. The air purifying device of claim 1, wherein at least one fan is selected from the list of: axial fan, centrifugal fan, and blower.

6. The air purifying device of claim 1, wherein at least one electrical power supply is selected from the list of: battery, rechargeable battery, fuel cell, capacitor, and supercapacitor, or any combination,
wherein at least a portion of said electrical power supply is optionally separated from said air filtering unit and electrically connected to said air filtering unit.

7. The air purifying device of claim 1, wherein at least one filter has at least one filter material that is selected from the list of: HEPA filter materials, filter materials used in various N95/KN95/N100 filters, electrostatically charged materials or trap layers, nanospun material-based filter materials, polypropylene fiber-based filter materials, nanoperforated filter materials, or any combination.

8. The air purifying device of claim 1 wherein said device filters at least 95% of 0.3 micron particles as specified by U.S. CDC/N.I.O.S.H. specifications for N95 respirators.

9. The air purifying device of claim 1 wherein said device filters approximately 99.97% of 0.3 micron particles as specified for HEPA filters.

10. The air purifying device of claim 1, wherein at least one fan is directly attached to the brim and air from the air filtering unit is substantially aligned with the target locations of the user.

11. The air purifying device of claim 10, wherein air passes through at least one filter before passing through said fan.

12. The air purifying device of claim 10, wherein air passes through at least one filter after passing through said fan.

13. The air purifying device of claim 1, wherein at least one fan is attached to a housing for air filtering components, wherein said housing is attached to said brim and the purified air from the air filtering unit is substantially aligned with the target locations of the user.

14. The air purifying device of claim 13, wherein air passes through at least one filter before passing through said fan.

15. The air purifying device of claim 13, wherein air passes through at least one filter after passing through said fan.

16. The air purifying device of claim 1, wherein at least one fan is attached very close to said brim in a way that maximizes air flow to target areas of the user.

17. The air purifying device of claim 16, wherein air passes through at least one filter before passing through said fan.

18. The air purifying device of claim 16, wherein air passes through at least one filter after passing through said fan.

19. The air purifying device of claim 1, wherein said air filtering unit is attached using shock minimizing means to head gear selected from the list of: football helmet, baseball cap, baseball helmet and head gear for athletics.

20. An air purifying device comprising: a brim, at least one air filtering unit, at least one air conducting means, and optional optical window,
wherein said air filtering unit comprise at least one filter, at least one fan, and at least one electrical power supply,
wherein said fan is located close to said brim,
wherein said air conducting means is selected from the list of: nozzles, fan housing nozzles, and substantially aligning filtered air from the air filtering unit with the target areas of the user without any additional air conduction means,
wherein said brim is selected from a list of: a brim that is a part of the housing for said air filtering unit and a brim that is a part of a separate head gear that is not a part of the air purifying device.

21. A filter comprising attachment means and filter material,
wherein said attachment means provides a tight seal between said filter and an air purifying device,
wherein said attachment means optionally holds said filter material in an approximate shape,
wherein said filter materials is selected from the list of HEPA filter materials, filter materials used in various N95/KN95/N100 filters, electrostatically charged materials or trap layers, nanospun material-based filter materials, polypropylene fiber-based filter materials, nanoperforated filter materials, other filters, or any combination,
wherein said air purifying device comprising: a brim, at least one air filtering unit, at least one air conducting means, and optional optical window,
wherein said air filtering unit comprise at least one of said filter, at least one fan, and at least one electrical power supply,
wherein said fan is located close to said brim,
wherein said air conducting means is selected from the list of: nozzles, fan housing nozzles, and substantially aligning filtered air with the target areas of the user without any additional air conduction means,
wherein said brim is selected from a list of: a brim that is a part of the housing for said air filtering unit and a brim that is a part of a separate head gear that is not a part of the air purifying device.

22. A filter of claim 21 wherein said head gear is selected from the list of: hat, cap, visor, face shield, helmet, hood, respirator, PAPR, powered air purifying respirator, football helmet, baseball cap, and baseball helmet, and head gear for athletics.
